(19) United States
(12) Patent Application Publication
(10) Pub. No.: US 2008/0308190 A1
(43) Pub. Date: Dec. 18, 2008

(54) Method and Apparatus for Cutting Circular Holes in Metal Objects

(76) Inventor: Harvey Mark Brunson, Nacogdoches, TX (US)

Correspondence Address: Colin P. Cahoon;CARSTENS & CAHOON, LLP, P.O. Box 802334, Dallas, TX, 75380, US

(21) Appl. No.: 11/762,849

(22) Filed: Jun. 14, 2007

(51) Int. Cl. B23K 7/00; B23K 7/10

(52) U.S. Cl. 148/201; 266/70

(57) ABSTRACT

Disclosed are a straight cutting torch and a circle cutting attachment that permits a welder to make an arcuate cut and/or a circle in confined places and without a template. Use of the disclosed method and apparatus can reduce preparation time and enhance productivity. The invention discloses using an attachment having a pivot point axis that is parallel to the cutting torch flame.

### BACKGROUND OF THE INVENTION

1. Technical Field

The present invention relates to an improved method for making an arcuate cut in a piece of metal and, more particularly, to an improved apparatus and method for using a straight cutting torch for making arcuate cuts in metal objects.

2. Description of Related Art

Cutting torches that operate with fuel gas and oxygen are often used to cut circular openings in metal objects, including pipes, vessels, and sheets of metal. U.S. Pat. No. 5,407,348 (“the '348 Patent”) provides an example of a cutting torch typically used for cutting circles in metal objects. As shown in FIG. 1 of the '348 Patent, the cutting torch 1 has a head 28 that has a 90 degree elbow and terminates in a cutting tip 32. Consequently, the cutting torch flame is typically in a perpendicular position relative to the axis defined by the body of the cutting torch and the rigid tubes 18 20 22, which carry the combustible gasses to the cutting tip 32.

Several devices have been developed to attach to such a cutting torch to permit operators to cut circles in metal objects. Such attachments are disclosed in U.S. Pat. Nos. 1,792,317; 2,489,061; 2,596,133; 3,139,471; 3,713,635; 3,804,391; 4,014,528; 4,157,814; 4,283,043; 4,606,528; 4,621,792; and 5,360,201.

One problem with such angled cutting torches and attachments can be best explained by referring to FIG. 1 of U.S. Pat. No. 4,621,792 (“the '792 Patent”). The figure depicts an operator using an angled cutting torch to make circles in a piece of metal. It would be difficult for the operator to cut a circle in the piece of metal 18 without walking around the entire periphery of the metal sheet 18.

While such angled cutting torch and cutting tool attachment may work for the embodiment depicted in FIG. 1 of U.S. Pat. No. 4,621,792, such angled cutting torch and cutting tool attachment is difficult to use in tight areas.

For example, FIG. 1 herein depicts a prior art angled cutting torch and attachment being used to cut a hole in a tubular piece of metal 30 that is in communication with two other vertical tubular members 32 34. One problem with the prior art angular cutting torch and cutting tool attachment is that an operator is unable to cut a circular hole in confined area without substantial repositioning himself and the cutting torch. Further, to cut the section of pipe indicated by numeral 12, the handle 13 of the cutting torch must have the ability to freely rotate to the opposite side of the circle and in the vicinity depicted by numeral 14. Similarly, in order to cut the circle in the section of pipe depicted by numeral 14, the handle 13 of the cutting torch must be able to move freely about the opposite side of the circle (e.g., area above numeral 12). Unfortunately, the vertical tubular member 32 prevents the handle 13 sufficient rotational access to permit the cutting head 17 to cut the area generally depicted by numeral 14. Similarly, the vertical tubular member 34 prevents the cutting torch handle from being able to make the cut generally depicted by numeral 12. Consequently, a need exists for an improved method for making accurate holes in pipes in small or confined areas.

One prior art solution to this problem involves using a template and applying the template, such as a saddle template, to the tubular member 30. A template can be used to provide an outline of the area to be cut. A marker can be used in conjunction with the template to establish an outline on the tubular member and an operator can then use a cutting torch manually to trace the outline freehand and make the cut. To manually make a precise and clean cut freehand still requires a very high level of skill to do precision work. Such method, however, fails to quickly provide a cut that is neat or accurate. Further, such method requires a high level of skill to make a precise cut.

Consequently, a need exists for cutting circles in tight places without a layout that reduces preparation time, results in a precise and clean cut and requires minimal skill level to do precision work.

### SUMMARY OF THE INVENTION

The proposed invention is directed towards an improved method for making an arcuate cut in a piece of metal. In one aspect, the invention comprises an attachment for a straight cutting torch that permits the cutting torch to accurately cut circular shaped holes in tubing or other metal objects. In one embodiment, the area required for making a circular cut is about the same as the area to be cut. The present invention thereby permits a welder to accurately cut circles in tight places and without a template. Consequently, the proposed invention can reduce preparation time and enhance productivity. The above as well as additional features and advantages will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a prior art angled cutting torch and attachment.

FIG. 2 is an exploded view of a straight cutting torch for cutting circles in metal objects in accordance with one embodiment of the present invention.

FIG. 3 is a perspective view of the circular cutting torch depicted in FIG. 2 being used to make an arcuate cut in a metal pipe in accordance with one embodiment of the present invention.

### DETAILED DESCRIPTION

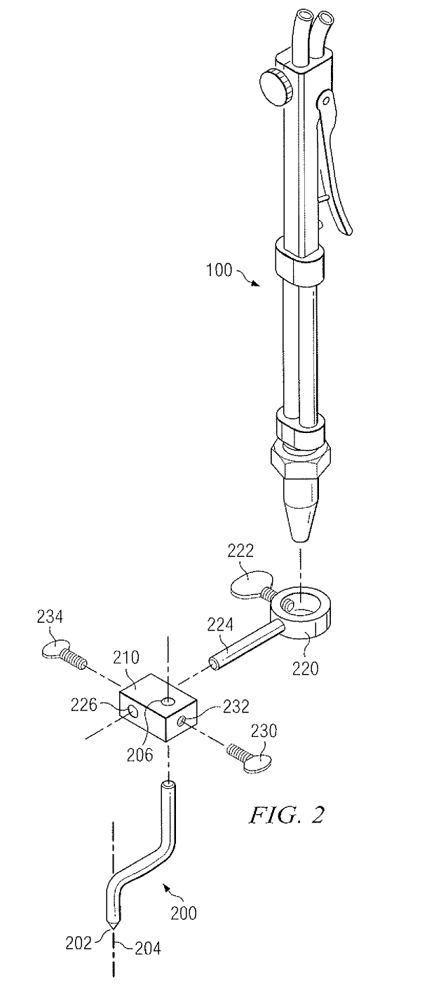

FIG. 2 is an exploded view of a circular cutting torch in accordance with one embodiment of the present invention. As shown in FIG. 2, a pivot rod 200 terminates at a pivot point 202. Although the pivot rod 200 as depicted has an upper part and an off-set lower part (terminating at the pivot point 202) connected by a middle section, such embodiment is merely for purposes of illustration and not limitation. Any pivot rod 200 can be used so long as at least a portion of the pivot rod 200 is parallel to a pivot point axis 204. As used herein, the term “pivot point axis” 204 is defined as the axis about which the pivot rod 200 rotates about the pivot point 202.

In the embodiment shown, an adjustable mounting block 210 comprises a pivot rod engagement passage 206 for receiving a pivot rod 200 and a pivot rod thumb screw 230 that can be threadably engaged to a threaded aperture 232 in communication with the pivot rod engagement passage 206.

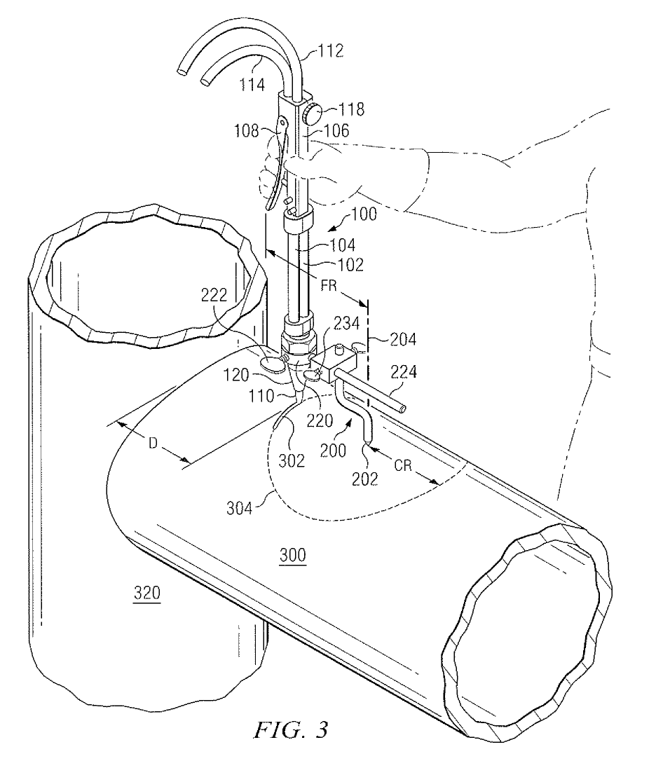

Also shown in FIG. 2 is a straight cutting torch 100 in accordance with one embodiment of the present invention. As used herein, the term-n “straight cutting torch” is defined as a cutting torch that provides a flame wherein the flame is substantially parallel to one or more rigid conduits 102 104 (shown in FIG. 3) which supply gas to the cutting torch. Consequently, in one embodiment, the longitudinal axis of the cutting head 120 is also parallel to the conduits 102 104.

Any type of straight cutting torch known in the art can be used in accordance with the present invention. Typically cutting torches operate with a fuel gas and oxygen. Acetylene is a commonly used fuel gas; however, other types of fuel gas can also be used including, for example, natural gas, propane, hydrogen and MAPP gas.

In one embodiment, the cutting torch 100 comprises a handle 106 further comprising a lever 118 for activating the flame 110 and a gas control valve 112 to control gaseous flow, and a cutting head 120 where the fuel gas and oxygen are mixed. One or more flexible hoses 112 114 can be attached to the cutting torch 100.

FIG. 3 is a perspective view of the straight cutting depicted in FIG. 2 being used to make an arcuate cut 302 in a metal pipe 300 in accordance with one embodiment of the present invention. As shown in FIG. 3, the cutting head 120 is disposed within a collar 220 and the collar thumb screw 222 holds the straight cutting torch 100 in place. An operator places the pivot point 202 in the desired location on the metal pipe 300. A center punch can optionally be used to help establish a depression in the metal pipe 300 for receiving the pivot point 202. The collar rod 224 can be adjusted as needed to get the desired cutting radius CR. Once the pivot point 202 is mated to the desired piece of metal 300, an operator can depress the lever 108 to activate the flame 110. The longitudinal axis of the flame or flame axis is substantially parallel to the axis of the cutting torch 100, In one embodiment, the flame axis intersects an operator's hand. The cutting torch 100 can then be rotated about the pivot point 202 to make an arcuate cut 302 having a cutting radius CR in the piece of metal 300. In one embodiment, an arcuate cut 302 can be made for an entire rotation about the pivot point axis 204 to cut a circle 304 out of the metal tube 300.

One advantage of the present invention is that it permits an operator to cut circular holes into a piece of metal or tubing in tight areas. The radius that a cutting torch requires to make an arcuate or circular cut as the cutting torch 100 is being rotated about the pivot point axis 204 can be called the footprint radius FR. As used herein, the term “footprint radius” is defined as the distance from the pivot point axis 204 to portion of the cutting torch 100 (including the rigid conduits 102 104, the handle 106, the lever 108, the control valve 118 and excluding the flexible hoses 112 114) furthest away from the pivot point axis 204.

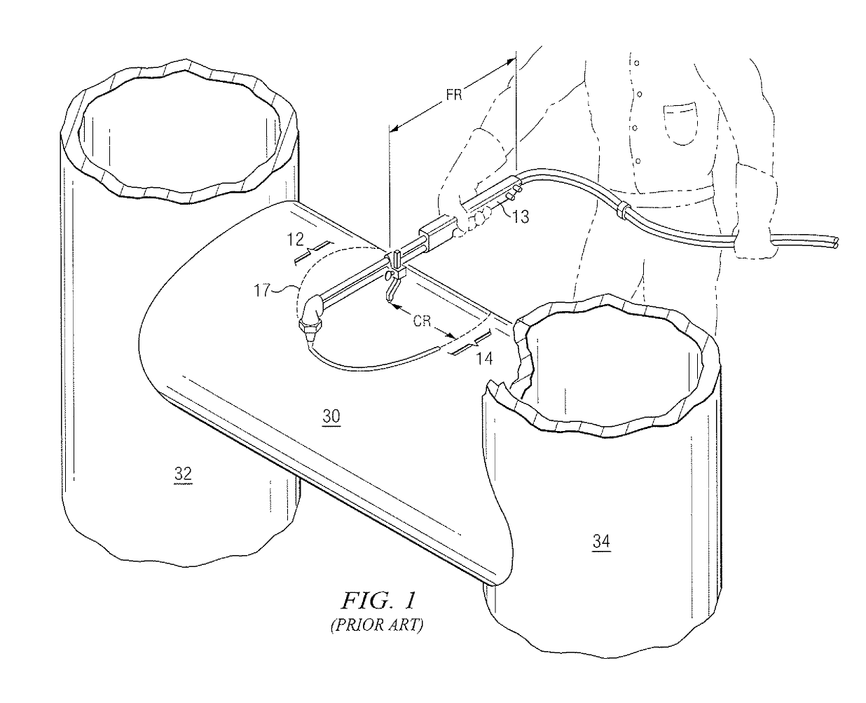

In FIG. 1, for example, the footprint radius FR is much larger than the cutting radius CR. Consequently, it is difficult to cut the circle in a piece of tubing using the angled cutting torch with an attachment shown in FIG. 1. In FIG. 3, on the other hand, an operator can easily cut a circle in the piece of metal pipe 300, even in the presence of an adjacent piece of pipe 320 in relative close proximity. In one embodiment, the footprint radius FR is within about 2 inches of the cutting radius CR.

In one embodiment, the footprint radius is less than or substantially equal to said cutting radius CR. In one embodiment, the footprint radius FR is within about 50% of the cutting radius CR and more preferably within about 30% of the cutting radius CR. For example, if the cutting radius is 6 inches, the footprint radius FR is preferably not more than about 9 inches and more preferably not more than about 7.8 inches.

In one embodiment, the distance 1) can be defined as the distance between an adjacent structure, such as an adjacent piece of piping 320, and an arcuate cut 302. In one embodiment, an arcuate cut is made within about 6 inches and more preferably within about 2 inches of an adjacent structure. In one embodiment, a circle 304 is cut in a piece of metal within about 6 inches and more preferably within about 2 inches of an adjacent structure. The present invention provides that a method that can be especially useful for adding pipe to manifolds. For example, once the circle 304 is completely cut out of the metal pipe 300 to create a hole, another piece of piping (not shown) can be welded to that hole. Thus, if the metal pipe 300 was a steam header, it would be relatively easy for an additional steam line to be attached to that steam header.

Further, the amount of time required to prepare a section of tubing or pipe to be cut is reduced because holes can be cut without the use of a template. Further, because the cutting torch 100 is attached to a pivot rod 200 and is being rotated about the pivot point axis 204, it provides a more precise and clean cut than can be achieved by manually cutting by trying to follow a line.

Further, the amount of time required to prepare a section of tubing or pipe to be cut is reduced because holes can be cut without the use of a template. Further, because the cutting torch 100 is attached to a pivot rod 200 and is being rotated about the pivot point axis 204, it provides a more precise and clean cut than can be achieved by manually cutting by trying to follow a line.

Additionally, circular cuts in accordance with one embodiment of the present invention can be made in a manner similar to making a circle with a closed fist. Consequently, there is less or no need for an operator to walk around the periphery of the metal object to make a circular cut or for an operator to twist his or her wrist while making a circular cut.

The present invention, in one embodiment, permits an operator to cut a hole by mere movement of an arm without moving the body or twisting the hand. In one embodiment, the present invention can provide holes having a radius of curvature of ½ inch to 12 inches. Further, because the present invention permits a welder to get into areas that were not accessible prior to this invention, substantial amounts of time can be saved since adjacent pieces of piping do not need to be dismantled.

Another advantage of the present invention is that, because it can cut into pieces of pipe in very tight areas, it is much more efficient for performing welding tasks on manifolds and in other tight areas such as “out of position” penetrations on the underside of vessels and piping where the welder, using prior art procedures, would be in the direct flow of fire, molten metal, and slag that is produced in such operations. The present invention eliminates the hazards associated with this type of out of position work, including difficult “overhead” procedures or procedures where the welder is located under the piece being cut because at most only a welder's hands and arms (which can be shielded with protective clothing) need be within the cutting radius CR. The rest of the welder's body can be kept safely out of the cutting radius CR where such molten metal and slag is produced. A depression can be made in the metal object, the pivot point 202 can be placed into the depression and an arcuate cut can be made. Prior art methods require a line to be drawn where the cut is desired and then requires a welder to manually cut through the line free hand. Consequently, the prior art method takes longer and produces a rougher cut than the present invention.

The present invention is especially useful for making circular penetrations in bulk heads and beams, which is a common practice in ship building, power plant, and petrochemical construction and renovations. The present invention can also advantageously facilitate the repair of boiler tube sheets more efficiently because the resizing of holes can be performed in place with a high degree of accuracy.

Another advantageous use of the present invention is in making radius cuts on flat plate piping and vessels where straight line intersections of angles are not permitted due to stress accumulation and therefore must have radius cuts at the intersections. For example, if a cut is to be made in a pressure vessel, the cut must have rounded or radiused corners. The present invention can produce nice, rounded corners. Prior art methods of such repair, however, require a line to be drawn where the cut is desired and subsequent manual or freehand cutting through that line. Again, such manually cutting often produces an undesirable, rough cut that must be radiused to meet the standards in the code.

The present invention is especially useful in cutting saddles in the ends of pipe without the use of complicated prior art procedures involving the use of available templates and drawing/layout procedures. For example, saddles are often cut into the end of a pipe so that a first pipe can be welded into a second pipe. (e.g., the left end of the metal pipe 300, which is the first pipe in this example, has a saddle to permits it to be welded into the second pipe 320) Unlike complicated prior art procedures, the present invention provides a simplified method to cut a saddle in the end of a pipe. A saddle can be cut into a pipe end by placing punch mark or depression at the end of the pipe where the saddle is desired. An arcuate cut can then be made by placing the pivot point 202 into the depression and using the apparatus of the present invention to make the arcuate cut. Another arcuate cut can then be made on the opposite side of the pipe to result in the saddle. Such method is much simpler than prior art procedures.

In addition, the present invention is far more efficient than prior art procedures in the installation of thread o-lets, weld-o-lets, extended body valves, and other piping and vessel components that require a circular penetration for installation because the smooth, slag-free cut produced with this present invention, coupled with the elimination of the drawing of layout lines reduces the time required in such procedures dramatically, and in some cases as much as 50% or more, especially where “out of position” and “overhead” cutting is required.

Further, because circular penetrations, hole, and radius cutting are procedures that are common and daily in various areas of welding and steel fabrication maintenance and construction, the present invention can advantageously be used in many different welding operations including, but not limited to job shops, machine shops, pipe and vessel shops, agriculture, and maintenance departments. Further, the present invention can advantageously be used in many different welding applications including, but not limited to, manufacturing, oil field, plumbing, HVAC, power plant, pipeline and construction.

While this invention has been particularly shown and described with reference to a preferred embodiment, it will be understood by those skilled in the art that various changes in form and detail may be made therein without departing from the spirit and scope of the invention.

What is claimed is:

1. An improved method for making an arcuate cut in a piece of metal, said method comprising the steps of:
a) providing a straight cutting torch (100);
b) attaching a pivot rod (200) having a pivot point (202) to said cutting torch (100), wherein said pivot point (202) comprises a pivot point axis (204), and wherein said pivot point axis (204) is oriented parallel to said cutting torch (100);
c) mating said pivot point (202) of said pivot rod (200) to said piece of metal (300);
d) rotating said cutting torch (100) about said pivot point (202) to make an arcuate cut (302) having a cutting radius (CR) in said piece of metal (300).

2. The method of claim 1 wherein said step c) further comprises mating said pivot point (202) substantially perpendicular to said piece of metal (300).

3. The method of claim 1 wherein said piece of metal (300) is tubular.

4. The method of claim 1 wherein said rotating at step d) comprises a footprint radius (FR) that is within about 2 inches of said cutting radius (CR).

5. The method of claim 1 wherein said rotating at step d) comprises a full rotation to make a circular cut.

6. The method of claim 5 wherein circular cut at step d) is made within about two inches of an adjacent structure.

7. The method of claim 5 wherein piece of metal (300) is tubular.

8. The method of claim 5 wherein said rotating at step d) comprises a footprint radius (FR) that is less than or substantially equal to said cutting radius (CR).

9. The method of claim 5 wherein rotating at step d) comprises a footprint radius that is within about 2 inches of said cutting radius (CR).

10. The method of claim 1 wherein said torch at step d) comprises a flame having a flame axis wherein said flame axis intersects an operator's hand.

11. The method of claim 1 wherein said rotating at step d) occurs manually.

12. An improved method for cutting circular holes in a piece of metal, said method comprising manually rotating a straight cutting torch (100) attached to a pivot point (202) about said a pivot point (202) to make a circular cut (302) in said piece of metal (300).

13. The method of claim 12 wherein circular cut at step d) is made within about two inches of an adjacent piece of metal.

14. The method of claim 12 wherein piece of metal (300) is tubular.

15. The method of claim 12 wherein said circular cut (302) further comprises a radius of curvature and wherein said rotating at step d) comprises a footprint radius (FR) within about two inches of said cutting radius (CR).

16. The method of claim 1 wherein said torch at step d) comprises a flame having a flame axis wherein said flame axis intersects an operator's hand.

17. A cutting torch for cutting circles in metal objects, said torch comprising:
a straight cutting torch (100); and
a pivot rod (200) having a pivot point (202) comprising a pivot point axis (204) wherein said pivot rod (200) is attached to said straight cutting torch (100) and wherein further said pivot point axis (204) is parallel to said cutting torch (100).
